(19) United States
(12) Patent Application Publication
(10) Pub. No.: US 2026/0264721 A1
(43) Pub. Date: Sep. 10, 2026

(54) METHOD AND APPARATUS WITH DRIVING TRAJECTORY GENERATION

(71) Applicant: Samsung Electronics Co., Ltd., Suwon-si (KR)

(72) Inventors: Yi ZHOU, Beijing (CN); Mengchuan WEI, Beijing (CN); Yiwei CHEN, Beijing (CN); Chao ZHANG, Beijing (CN); Weiming LI, Beijing (CN); Sung Hyun CHUNG, Suwon-si (KR); Jaewook YOO, Suwon-si (KR); Dongwook LEE, Suwon-si (KR); Daehyun JI, Suwon-si (KR)

(73) Assignee: Samsung Electronics Co., Ltd., Suwon-si (KR)

(21) Appl. No.: 19/555,321

(22) Filed: Mar. 3, 2026

(30) Foreign Application Priority Data
Mar. 5, 2025 (CN) 202510259220.4
Nov. 4, 2025 (KR) 10-2025-0164509

(51) Int. Cl. B60W 60/00; G06T 7/20; G06V 10/77; G06V 20/58

(52) U.S. Cl. CPC B60W 60/0027; G06T 7/20; G06V 10/7715; G06V 20/58; G06T 2207/30241; G06T 2207/30252

(57) ABSTRACT

A method of generating an autonomous driving trajectory includes generating a scene token and a first trajectory based on a collected image, obtaining a first query command including a first query for a logic of trajectory generation and a second query for safety of the trajectory, and generating a third trajectory based on the scene token, the first trajectory, and the first query command using a large language model (LLM). The third trajectory is obtained by processing a second trajectory based on second information obtained in response to the second query, the second trajectory is obtained based on first information obtained in response to the first query, and the first information and the second information are obtained based on the scene token, the first trajectory, and the first query command.

### CROSS-REFERENCE TO RELATED APPLICATIONS

This application claims the benefit under 35 USC § 119(a) of Chinese Patent Application No. 202510259220.4, filed on Mar. 5, 2025, in the China National Intellectual Property Administration, and Korean Patent Application No. 10-2025-0164509, filed on Nov. 4, 2025, in the Korean Intellectual Property Office, the entire disclosures of which are incorporated herein by reference for all purposes.

### BACKGROUND

### 1. Field

The following description relates to a method and apparatus with driving trajectory generation using a large language model (LLM).

### 2. Description of Related Art

Autonomous driving refers to the ability of a vehicle to drive itself without human intervention. An autonomous driving technology is already being applied in various fields, including personal cars, urban electric buses, and taxis. With the continued advancement of technology, the autonomous driving technology is expected to be utilized and developed more widely in the future.

Ensuring safety, explainability, and/or generalizability capability may be crucial for the advancement of autonomous driving systems. Traditional autonomous driving systems employ modular designs and built-in error detection mechanisms, but may be underperforming and have limited generalization capability when dealing with complex situations. End-to-end autonomous driving systems may improve performance in complex scenes by directly optimizing driving strategies in a data-driving manner.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a method of generating an autonomous driving trajectory includes generating a scene token and a first trajectory based on a collected image, obtaining a first query command including a first query for a logic of trajectory generation and a second query for safety of the trajectory, and generating a third trajectory based on the scene token, the first trajectory, and the first query command using a large language model (LLM). The third trajectory is obtained by processing a second trajectory based on second information obtained in response to the second query, the second trajectory is obtained based on first information obtained in response to the first query, and the first information and the second information are obtained based on the scene token, the first trajectory, and the first query command.

The second information may include at least one of information about whether a direction of the second trajectory corresponds to a direction of a navigation command or information about whether a yaw angle between any pair of adjacent trajectory points in the second trajectory exceeds a first threshold value.

The generating of the third trajectory may include, based on determining, according to the second information, that the direction of the second trajectory does not match the direction of the navigation command, adjusting a vertical coordinate value of a trajectory point within the second trajectory so that the direction of the second trajectory corresponds to the direction of the navigation command, and determining the third trajectory corresponding to the adjusted second trajectory.

The generating of the third trajectory may include, based on determining, according to the second information, that the yaw angle between any pair of adjacent trajectory points in the second trajectory exceeds the first threshold value, incrementally increasing a horizontal coordinate value of a trajectory point within the second trajectory, adjusting a fluctuation range of the vertical coordinate value to be less than a second threshold value, and determining the third trajectory corresponding to the adjusted second trajectory.

The generating of the third trajectory may include generating description information about processing of the second trajectory based on the second information, and obtaining the third trajectory by processing the second trajectory based on the description information.

The generating of the third trajectory may include generating the first information and the second information based on the scene token, the first trajectory, and the first query command, generating the second trajectory for the first information based on the scene token, the first trajectory, the first query command, and the first information, and obtaining the third trajectory by processing the second trajectory based on the second information.

The first information may include at least one of information related to a driving scene, information related to a key object in the driving scene, information related to a driving action to be performed, or information related to prediction of the second trajectory.

The generating of the third trajectory may include obtaining a second query command by embedding the first trajectory into the first query command, and generating the third trajectory based on the scene token and the second query command.

The generating of the scene token and the first trajectory based on the collected image may include extracting a visual feature from the image, obtaining a scene query representation comprising information indicating semantics of a driving scene, and a perception query representation comprising information indicating at least one object in the driving scene, updating the scene query representation and the perception query representation based on the visual feature, generating the scene token based on the updated perception query representation and the updated scene query representation, and generating the first trajectory based on the updated perception query representation.

The updating of the scene query representation and the perception query representation based on the visual feature may include obtaining a perception memory including a previously updated perception query representation and/or a previously updated scene query representation, and updating the scene query representation and the perception query representation based on the visual feature and the perception memory.

In one general aspect, an electronic device includes one or more processors including processing circuitry, and a memory storing instructions, wherein the instructions, when executed by the one or more processors, cause the electronic device to generate a scene token and a first trajectory based on a collected image, obtain a first query command including a first query for a logic of trajectory generation and a second query for safety of the trajectory, and generate a third trajectory based on the scene token, the first trajectory, and the first query command using an LLM, the third trajectory is obtained by processing a second trajectory based on second information obtained in response to the second query, the second trajectory is obtained based on first information obtained in response to the first query, and the first information and the second information are obtained based on the scene token, the first trajectory, and the first query command.

The second information may include at least one of information about whether a direction of the second trajectory corresponds to a direction of a navigation command or information about whether a yaw angle between any pair of adjacent trajectory points in the second trajectory exceeds a first threshold value.

The instructions, when executed by the one or more processors, may cause the electronic device to, based on determining, according to the second information, that the direction of the second trajectory does not match the direction of the navigation command, adjust a vertical coordinate value of a trajectory point within the second trajectory so that the direction of the second trajectory corresponds to the direction of the navigation command, and determine the third trajectory corresponding to the adjusted second trajectory.

The instructions, when executed by the one or more processors, may cause the electronic device to, when the yaw angle between any pair of adjacent trajectory points in the second trajectory exceeds the first threshold value, incrementally increase a horizontal coordinate value of a trajectory point within the second trajectory, adjust a fluctuation range of the vertical coordinate value to be less than a second threshold value, and determine the third trajectory corresponding to the adjusted second trajectory.

The instructions, when executed by the one or more processors, may cause the electronic device to generate description information about processing of the second trajectory based on the second information, and obtain the third trajectory by processing the second trajectory based on the description information.

The instructions, when executed by the one or more processors, may cause the electronic device to generate the first information and the second information based on the scene token, the first trajectory, and the first query command, generate the second trajectory for the first information based on the scene token, the first trajectory, the first query command, and the first information, and obtain the third trajectory by processing the second trajectory based on the second information.

The first information may include at least one of information related to a driving scene, information related to a key object in the driving scene, information related to a driving action to be performed, or information related to prediction of the second trajectory.

The instructions, when executed by the one or more processors, may cause the electronic device to obtain a second query command by embedding the first trajectory into the first query command, and generate the third trajectory based on the scene token and the second query command.

The instructions, when executed by the one or more processors, may cause the electronic device to extract a visual feature from the image, obtain a scene query representation comprising information indicating semantics of a driving scene, and a perception query representation comprising information indicating at least one object in the driving scene, update the scene query representation and the perception query representation based on the visual feature, generate the scene token based on the updated perception query representation and the updated scene query representation, and generate the first trajectory based on the updated perception query representation.

In one general aspect, in a non-transitory computer-readable storage medium storing instructions executable in a hardware device, the instructions configured to cause the hardware device to: generate a scene token and a first trajectory based on a collected image, obtain a first query command including a first query for a logic of trajectory generation and a second query for safety of the trajectory, and generate a third trajectory based on the scene token, the first trajectory, and the first query command using an LLM, the third trajectory is obtained by processing a second trajectory based on second information obtained in response to the second query, the second trajectory is obtained based on first information obtained in response to the first query, and the first information and the second information are obtained based on the scene token, the first trajectory, and the first query command.

Other features and aspects will be apparent from the following detailed description, the drawings, and the claims.

### BRIEF DESCRIPTION OF THE DRAWINGS

FIGS. 1A and 1B illustrate an example of a method of generating an autonomous driving trajectory, according to one or more embodiments.

FIG. 2 illustrates an example of an autonomous driving system, according to one or more embodiments.

FIG. 3 illustrates an example of a query command in an autonomous driving system, according to one or more embodiments.

FIG. 4A illustrates an example of a scene tokenizer, according to one or more embodiments.

FIG. 4B illustrates an example of an operation of a scene tokenizer, according to one or more embodiments.

FIGS. 5A to 5C illustrate results obtained through a method of generating an autonomous driving trajectory, according to one or more embodiments.

FIG. 6 illustrates an example of an electronic device, according to one or more embodiments.

Throughout the drawings and the detailed description, unless otherwise described or provided, the same or like drawing reference numerals will be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

Examples and embodiments described herein may be implemented as various types of products such as, for example, a personal computer, a laptop computer, a tablet computer, a smart phone, a television, a smart home appliance, an intelligent vehicle, a kiosk, and a wearable device. Hereinafter, the examples will be described in detail with reference to the accompanying drawings. When describing the examples with reference to the accompanying drawings, like reference numerals refer to like elements and a repeated description related thereto will be omitted.

At least some functions of an apparatus or electronic device provided in examples may be implemented through an artificial intelligence (AI) model. For example, at least one module among various modules of the apparatus or the electronic device may be implemented through the AI model. AI-related functions may be performed by a non-volatile memory, a volatile memory, and a processor.

The processor may include at least one processor. In this case, the at least one processor may be a general-purpose processor (e.g., a CPU, an application processor (AP), etc.) or a graphics-dedicated processing unit (e.g., a GPU, a vision processing unit (VPU), and/or an AI-dedicated processor (e.g., a neural processing unit (NPU)).

The at least one processor may control processing of input data according to a predefined operation rule or an AI model stored in a non-volatile memory and a volatile memory. The predefined operation rule or the AI model may be provided through training or learning.

Here, providing the predefined operation rule or the AI model through learning may indicate acquiring a predefined operation rule or an AI model having desired features by applying a learning algorithm to a plurality of pieces of training data. The training may be performed by an apparatus or electronic device having an AI function according to an example, or by a separate server, apparatus, and/or system.

The AI model may include neural network layers. Each layer may perform a neural network operation by calculating between input data (e.g., a calculation result of a previous layer and/or input data of the AI model) of the layer and a plurality of weight values of a current layer. A neural network may include, for example, a convolutional neural network (CNN), a deep neural network (DNN), a recurrent neural network (RNN), a restricted Boltzmann machine (RBM), a deep belief network (DBN), a bidirectional recurrent deep neural network (BRDNN), a generative adversarial network (GAN), and a deep Q network, but is not limited thereto.

The learning algorithm may be a method of training a predetermined target device, for example, a robot, based on a plurality of pieces of training data and enabling, allowing, or controlling the predetermined target device to perform determination or prediction. The learning algorithm may include, but is not limited to, for example, supervised learning, unsupervised learning, semi-supervised learning, or reinforcement learning.

A method provided in examples may be relevant to one or more technical fields, such as voice, language, image, video, or data intelligence.

In some embodiments, in voice or language processing, in a method performed by an electronic device, a method of recognizing a voice of a user and interpreting intent of the user may include receiving a voice signal as an analog signal through a voice collection device (e.g., a microphone), and converting a voice portion into a computer-readable text using an automatic speech recognition (ASR) model. Utterance intent of the user may be obtained by interpreting the converted text using a natural language understanding (NLU) model. The ASR model or the NLU model may be an AI model. The AI model may be processed by AI-specific processors designed with a hardware architecture designated for AI model processing. The AI model may be obtained through training. Here, “obtaining through training” may indicate obtaining a predefined operating rule or an AI model with a desired feature (or an objective) by training a basic AI model with a plurality of pieces of training data through a training algorithm. Linguistic understanding is a technique used to recognize and apply/process a human language/a text, including natural language processing, machine translation, dialogue system, question and answering, or speech recognition/synthesis.

In some embodiments, in image or video processing, a method of identifying a trajectory (e.g., a vehicle trajectory) may include obtaining output data for identifying an image or various features, knowledge, information, and the like within an image by using image data as input data of an AI model. The AI model may be configured through training, which may involve configuring an AI model with a predefined operating rule or desired feature (or an objective) by training the AI model with pieces of training data through a training algorithm. Embodiments described herein relate to the field of visual understanding using AI technology, which may involve recognizing and processing objects in ways that may be similar to human vision, and may include, for example, object recognition, object tracking, image retrieval, person recognition, scene recognition, three-dimensional (3D) reconstruction/positioning, or image enhancement.

In the field of data intelligence processing, a method of inferring or predicting a trajectory by utilizing various knowledge using an AI model may be recommended/performed among methods performed by the electronic device. The processor of the electronic device may perform preprocessing operations on data to convert the data into a form suitable for use as an input to an AI model. The AI model may be obtained/configured through training, which may involve obtaining a predefined operating rule or an AI model with a desired feature (or an objective) by training a basic AI model with pieces of training data through a training algorithm. Inference or prediction is a technology that performs logical inference (also referred to as prediction) by determining information such as knowledge-based inference, optimization prediction, preference-based planning, or recommendation.

Although embodiments are described herein as generating a driving trajectory/path for autonomous driving, the embodiments are not limited to the application of autonomous driving. The embodiments described herein may be used to generate driving paths/trajectories that may be used in other applications, for example, assisted-driving applications.

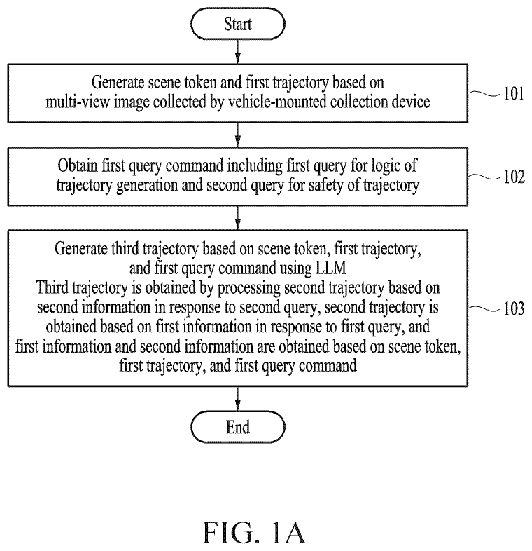

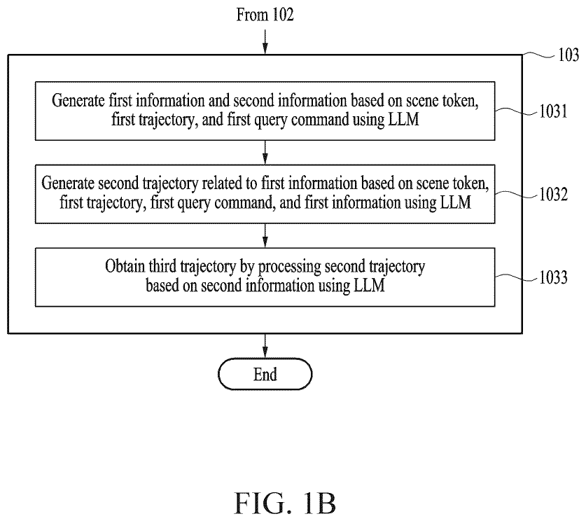

FIGS. 1A and 1B illustrate an example of a method of generating an autonomous driving trajectory, according to one or more embodiments.

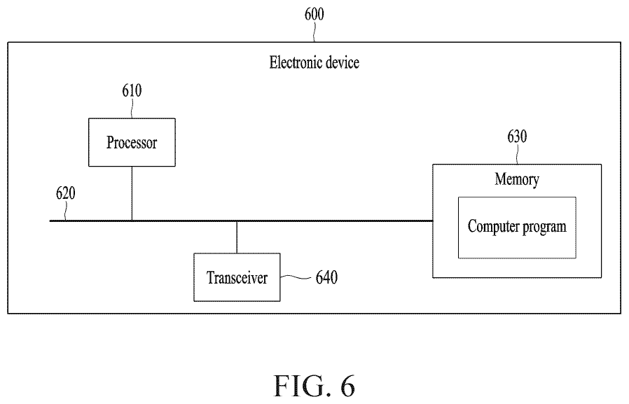

For ease of description, operations 101 to 103 and 1031 to 1033 are described as being performed using an electronic device 600 illustrated in FIG. 6. However, operations 101 to 103 and 1031 to 1033 may be performed by another suitable electronic device in a suitable system. In addition, an electronic device may be (or may be incorporated in) a vehicle that includes an autonomous driving system.

In operation 101, the electronic device 600 may generate a scene token and a first trajectory based on a collected image.

In some implementations, the collected image may be a multi-view image. For example, a vehicle-mounted collection device may be installed on an autonomous vehicle. The vehicle-mounted collection device may be, for example, a vehicle-mounted camera, a vehicle-mounted video camera, or the like, and examples are not limited thereto. The number of vehicle-mounted collection devices may be one or more, which may collect images of the environment around the autonomous vehicle from different angles during driving. A person skilled in the art may set a position in the autonomous vehicle where the vehicle-mounted collection device is installed according to actual situations, and examples herein are not limited thereto.

According to an example, optionally, the number of multi-view images may be one frame or multiple frames; in the latter case, the multi-view image may also be referred to as a multi-view video. While the term “collected image” is used herein, the phrase also refers to derivations of a collected image, e.g., an image that has been subjected to various forms of image processing, a feature map extracted from a collected image, and so forth. That is to say, “collected image” is not limited to images in the form they have when provided by an image capture device.

The collected image may be, but is not limited to, an red, green, and blue (RGB) image, and may also be an image in another color mode (e.g., grayscale, infrared, depth map image, etc.).

According to an example, the electronic device 600 may generate the scene token and the first trajectory based on the collected image. For example, the scene token may represent information within a driving scene, semantics of the driving scene, objects, relationships between objects, and the like.

In some example implementations, the scene token represents information about a 3D scene by adopting a 3D scene token, and may be expressed as a predetermined S×C tensor, where S represents the number of scene tokens and C represents the number of channels (e.g., feature channels). The first trajectory may also be referred to as an initial trajectory proposal and may be expressed as a predefined T×2 tensor. T represents the number of trajectory points within a predetermined time in the predicted future, and 2 represents two-dimensional (2D) coordinates of each trajectory point. As a non-limiting example, T may be 6, and the predetermined time may be 3 seconds. In this example, the first trajectory has six trajectory points at intervals of 0.5 second within a 3 second timespan (e.g., the next 3 seconds).

According to an example, prediction of the first trajectory may allow a model to directly analyze and refine a specific trajectory, may alleviate issues associated with uncertain trajectory prediction, and may improve an overall decision process.

In operation 102, the electronic device 600 may obtain a first query command. The first query command may include a first query for a logic of trajectory generation and a second query for safety of the trajectory.

In some implementations, the query command may be a description text, a question, or the like about specific information within an image, and may be used to determine a relevant interpretation of a predicted trajectory. The query command may also be referred to as a query text. The first query command may be a predefined text or may be obtained by converting (e.g., encoding) the predefined text, and the described examples are not limited thereto.

According to an example, the first query for the logic of the trajectory generation may be used to determine knowledge related to the trajectory generation (e.g., information about the basis upon which the trajectory was generated), thereby improving the explainability of the trajectory generation. The second query for the safety of the trajectory may be used to determine safety-related knowledge, thereby improving the safety of the trajectory.

In operation 103, the electronic device 600 may generate a third trajectory based on the scene token, the first trajectory, and the first query command using a large language model (LLM). The third trajectory may be obtained by processing a second trajectory; the processing of the second trajectory based on second information and performed in response to the second query. The second trajectory may be obtained based on first information in response to the first query, and the first information and the second information may be obtained based on the scene token, the first trajectory, and the first query command.

According to an example, the LLM may be/include a visual language model (VLM), or the like, but the described examples are not limited thereto. VLMs are multimodal models that blend computer vision and natural language processing to understand, interpret, and generate content from both image/video and text inputs/modes. By combining a vision encoder with a Large Language Model (LLM), for example, VLMs can perform tasks like visual question answering (VQA) and object detection. The LLM may be applied to the field of autonomous driving to improve reliability of the trajectory prediction.

The electronic device 600 may input the scene token, the first trajectory, and the first query command to the LLM. The LLM may output the generated third trajectory based thereon. The first information may be understood as knowledge related to the logic of the trajectory generation and may be extracted from an input during a process of processing the LLM. The second trajectory may be predicted based on the first information, which may improve trajectory prediction performance in complicated scenes, for example. The second trajectory may also be expressed as a predefined T×2 tensor, for example. T represents the number of trajectory points within a predetermined time in the predicted future, and 2 represents 2D coordinates of each trajectory point. The second information may be understood as knowledge related to the safety of the trajectory extracted from the input during the processing of the LLM, and the third trajectory may be obtained by processing the second trajectory based on the second information, which may contribute to improving trajectory safety.

According to an example, the first information and the second information may be integrated and utilized to improve the generalization capability of the autonomous driving system. The first information and/or the second information may also be output by a model, and this may improve the explainability of the model.

Operation 103 may specifically include the following operations.

In operation 1031, the electronic device 600 may generate the first information and the second information based on the scene token, the first trajectory, and the first query command using the LLM.

In operation 1032, the electronic device 600 may generate the second trajectory related to the first information based on the scene token, the first trajectory, the first query command, and the first information using the LLM.

In operation 1033, the electronic device 600 may obtain the third trajectory by processing the second trajectory based on the second information using the LLM.

Therefore, methods of generating the autonomous driving trajectory may effectively combine knowledge related to the logic of the trajectory generation with knowledge related to the safety of the trajectory, thereby simultaneously improving the safety, the explainability, and the generalization capability.

In some implementations, the second information may include at least one of (i) information about whether a direction of the second trajectory matches a direction of a navigation command (hereinafter, referred to as a direction matching information) and/or (ii) information about whether a yaw angle between each pair of adjacent trajectory points among the second trajectory exceeds a first threshold value (hereinafter, referred to as yaw angle information).

In some implementations, the direction matching information may primarily consider whether the trajectory violates the navigation command. A method of determining whether the trajectory violates the navigation command may include first converting the trajectory into a directional action, and then comparing whether the directional action of the trajectory matches the navigation command. When they do not match, the trajectory may be determined to have violated the navigation command.

The third trajectory may be obtained by processing the second trajectory based on the second information. In some implementations, a processing method thereof may be as follows. When the direction of the second trajectory does not match the direction of the navigation command, the electronic device 600 may adjust, for example, a vertical coordinate (y-axis) value of a trajectory point within the second trajectory to match the direction of the trajectory with the direction of the navigation command, and may set the adjusted second trajectory as the third trajectory. An optimization method may be used (when the trajectory violates the navigation command) to adjust the y-value of the trajectory point to match the direction of the trajectory with the navigation command.

According to an example, the yaw angle information may primarily consider/reflect whether the trajectory is not smooth. A method of determining whether the trajectory is not smooth may be to determine whether a yaw angle between consecutive points in the trajectory exceeds a predetermined threshold value (e.g., a first threshold value, which is an angle). For example, when the trajectory includes six points, five yaw angles may be calculated between each pair of adjacent points, and it may be determined whether any of the five yaw angles exceed the first threshold value. When all five yaw angles are less than or equal to the first threshold value, the trajectory may be determined to be smooth. When even one yaw angle exceeds the first threshold value, the trajectory may be determined to be not smooth, which may result in abrupt steering of the vehicle, departure into an undriveable area, loss of vehicle control, etc. The first threshold value may be set (e.g., by an engineer or user) according to the actual situation, and may be set to, as a non-limiting example, 1.1 or the like.

As noted, the third trajectory may be obtained by processing the second trajectory based on the second information. A processing method thereof may be as follows. When a yaw angle between at least one pair of adjacent trajectory points within the second trajectory exceeds the first threshold value, the electronic device 600 may gradually increase a horizontal coordinate (x-axis) value of the corresponding trajectory point within the second trajectory, and adjust a fluctuation range of the vertical coordinate (y-axis) value to be less than a second threshold value (which may be understood as preventing the vertical coordinate value from fluctuating, or may directly instruct the LLM to prevent the vertical coordinate value from fluctuating and cause the LLM to process based on that understanding), and use the adjusted second trajectory as the third trajectory. Regarding the adjusting the horizontal coordinate value of the corresponding trajectory point, the corresponding trajectory point may be adjusted to mitigate the sharp yaw angle. The “corresponding trajectory point” here is the second point in the pair, as the subsequent point may be adjusted relative to the preceding one to smooth the trajectory. Regarding the fluctuation range, this range may be a metric used to prevent the vehicle from wobbling laterally. The fluctuation range may be defined as the magnitude of difference (or rate of change) in the vertical coordinate (y-axis) values between adjacent trajectory points.

According to an example, when the trajectory is not smooth, a corresponding trajectory optimization method may be as follows. The electronic device 600 may gradually increase an x-value of the trajectory, and a y-value of the trajectory point to not fluctuate (particularly when a speed of the autonomous vehicle is low), thereby improving the smoothness of the trajectory.

As an example, when neither of the two situations described above occurs, the trajectory may be considered safe. Other trajectory safety tests may be used, for example, by testing the trajectory against performance limits of the ego vehicle.

When the trajectory is determined to be safe, the electronic device 600 may directly output the second trajectory and use it as the third trajectory, or may output the second trajectory as the third trajectory based on internal processing of the LLM (i.e., may be fine-tuned by the LLM). That is, the second trajectory and the third trajectory may be identical or highly similar to each other.

According to an example, when the electronic device 600 processes the second trajectory based on the second information to obtain the third trajectory, the electronic device 600 may generate description information about the processing of the second trajectory (such processing based on the second information). In addition, the electronic device 600 may process the second trajectory based on the description information to obtain the third trajectory.

In some implementations, an operation of processing the second trajectory based on the second information to obtain the third trajectory may be a reflection operation, and the reflection may be as follows. The electronic device 600 may simulate and evaluate the safety of a given trajectory, describe an optimization method, and output an optimized trajectory.

As a non-limiting example, the second information, the description information, and the like may all be expressed in a manner of a language/voice.

Regarding the reflection operation, a single reflection template may be provided, which may be expressed as follows: “given the trajectory as being <each input trajectory point>, the trajectory may be determined as <description of safety and specific situation>. Therefore, <optimization method> is to be performed, and the planned trajectory may be <each optimized trajectory point>.”

According to an example, each input trajectory point may correspond to the second trajectory, and each optimized trajectory point may correspond to the third trajectory. Alternatively, it may be expressed in other languages, for example: “If follow <input_traj>, <safety_and_outcome>. Hence you should <how_to_optimize>, here is the planning trajectory <optimized_traj>.”

An example of one reflection is presented in Table 1, where “PT” stands for “planned trajectory”.

TABLE 1

| Safety | If the trajectory is [(+1.31, −0.01), (+2.77, −0.04), (+4.35, −0.04), (+6.00, −0.04), |
|---|---|
| | (+7.74, −0.05), (+9.63, −0.06)], the trajectory is confirmed to be |
| | safe and feasible. Therefore, the trajectory may be followed or adjusted |
| | slightly, and the planned trajectory is [PT, (+1.70, 0.0), (+2.84, −0.02), |
| | (+4.06, −0.03), (+5.26, 0.0), (+6.52, +0.02), (+7.95, +0.08)]. |
| Violation of | If the trajectory is [(+0.73, −0.01), (+1.73, +0.05), (+3.05, +0.18), (+4.56, +0.50), |
| navigation | (+6.15, +1.15), (+7.86, 1.81)], the future action of the trajectory |
| command | is determined to be going straight, which violates the navigation |
| | command of a left turn. Therefore, the y-axis value of the trajectory |
| | should be increased to adjust the direction to the left, and the planned |
| | trajectory is [PT, (+0.63, 0.0), (+1.67, +0.08), (+2.94, +0.34), (+4.36, +0.93), |
| | (+5.66, +1.89), (+6.93, +3.41)]. |
| Trajectory non- | When the trajectory is [(+1.19, −0.02), (+1.97, −0.03), (+2.42, −0.04), |
| smoothness | (+2.60, −0.05), (+2.61, −0.06), (+2.60, −0.06)], it is confirmed that a |
| | driving direction of the trajectory is temporally discontinuous. Therefore, |
| | it may be ensured that the x-axis value of the trajectory does not |
| | decrease, and secondly, the trajectory does not wobble horizontally |
| | when an ego vehicle speed is low. The planned trajectory is[PT, (+1.22, −0.02), |
| | (+2.08, −0.03), (+2.56, −0.04), (+2.77, −0.05), (+2.84, −0.05), (+2.88, −0.06)]. |

The first information may include at least one of (i) information related to a driving scene, (ii) information related to a key object within the driving scene, (iii) information related to a driving action to be performed, or (iv) information related to prediction of the second trajectory.

Regarding the (i) information related to the driving scene, such information may be understood as information or a response describing a current driving scene. The information related to the driving scene may be referred to as scene description information or scene response. The information related to the driving scene may include, as non-limiting examples, information indicating road conditions (e.g., parking lots, or intersections), traffic elements (e.g., pedestrians, vehicles, or traffic lights), time of day, weather conditions, and the like and may include, for example, information indicating what the weather is like in the scene and whether pedestrians and vehicles are present in the scene.

The scene description information may be expressed in a manner of a language/voice.

In some implementations, the electronic device 600 may recognize surrounding information and determine a location using 3D point cloud data. Regarding how the point cloud data relates to the previous description, referring to the (i) information related to a driving scene, because the 3D point cloud data may be used to recognize surrounding information and determine the vehicle's location, it may be used as input data that supplements the scene description in a broad sense. That is to say, the 3D point cloud data may primarily be used to determine the scene information.

Regarding the (ii) information related to a key object within the driving scene, such information may be understood as a response related to a key object to be aware of in the driving scene. The information related to the key object within the driving scene may be referred to as awareness or attention information or response. The information related to the key object within the driving scene may be used to identify a key target that may affect a driving behavior, and may include, for example, location(s) or the like of vehicles or pedestrians to be aware of, since the vehicles or the pedestrians are close to the ego vehicle.

The attention information may be expressed in a manner of a language/voice.

Regarding the (iii) information related to the driving action to be performed, such information may be understood as a response related to an action to be performed by the ego vehicle in the future. The information related to the driving action to be performed may be referred to as decision information or response. As non-limiting examples, a directional action may include going straight, turning left, turning right, stopping, and the like, and a speed action may include accelerating, decelerating, maintaining a constant speed, stopping, and the like.

In some implementations, the driving action may be selected from predefined selection options.

The decision information may also include a reason or basis for the decision. For example, the speed of the next 3 seconds may be predicted and analyzed based on the current scene and the key target to describe the reason for the decision.

According to an example, the decision information may be expressed in a manner of a language/voice.

Regarding the (iv) information related to the prediction of the second trajectory, such information may be understood as a response related to the predicted trajectory. The information related to the driving action to be performed may be referred to as trajectory information or response. This may predict some description of the trajectory, and may also include point coordinate information of a specific trajectory. For example, a safe and feasible 3-second trajectory may be predicted based on the driving action and the first trajectory, which may include six waypoints (or trajectory points), as a non-limiting example. That is, point coordinate information of the predicted second trajectory may be included in the trajectory information.

Similarly, a query command corresponding to the trajectory information may also include point coordinate information of the first trajectory. Specifically, when the electronic device 600 generates the third trajectory, the electronic device 600 may obtain a second query command by embedding the first trajectory into the first query command, and generate the third trajectory based on the scene token and the second query command.

According to an example, (ii) the information related to the key object within the driving scene, (iii) the information related to the driving action to be performed, and/or (iv) the information related to the prediction of the second trajectory may be predicted using a model trained based on labeling within a dataset.

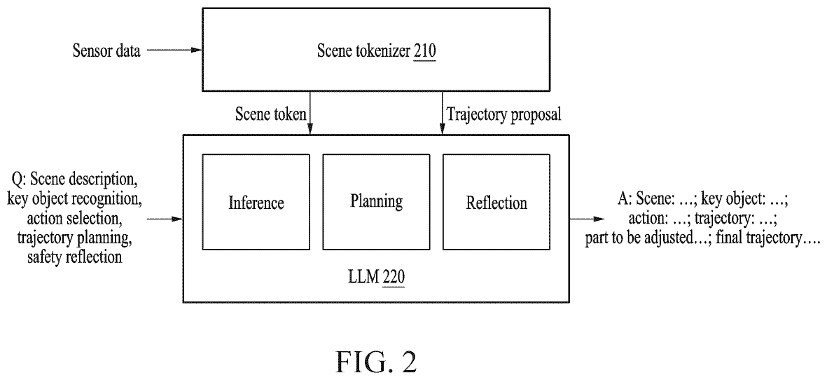

FIG. 2 illustrates an example of an autonomous driving system, according to one or more embodiments.

The description provided with reference to FIGS. 1A and 1B is generally applicable to FIG. 2.

Referring to FIG. 2, one or more blocks thereof may be implemented by a special-purpose hardware-based computer that performs a predetermined function or a combination of computer instructions and special-purpose hardware.

Various of the techniques described herein may be used for autonomous driving trajectory planning. As shown in FIG. 2, an end-to-end autonomous driving system may be based on an LLM 220 (or a VLM). The autonomous driving system may integrate inference, planning, and reflection. Specifically, through a scene tokenizer 210, sensor data (from sensors such as the vehicle-mounted capture device(s)) may be encoded into relevant scene information (in the form of a scene token) and an initial trajectory proposal (e.g., the first trajectory). Next, a series of query commands Q including scene description, key object recognition, action selection, trajectory planning, and/or safety reflection may be introduced to represent knowledge about a prediction logic, specific trajectory information, safety evaluation, and optimization trajectory. Subsequently, the corresponding knowledge may be extracted from the scene by training the relationships between the query command, the trajectory proposal, and the scene token by using pre-trained parameters of the LLM. Finally, the network may directly output inference related to the trajectory, the predicted trajectory, and safety evaluation thereof, and provide an optimized trajectory.

Referring to FIG. 2, the autonomous driving system receives sensor data as an input to the scene tokenizer 210, and generates a scene token containing semantic information within the scene and an initial trajectory proposal. The generated scene token and trajectory proposal may be input into the LLM 220.

The LLM 220 may sequentially respond to a series of queries Q including semantics of a driving scene, a key object, a performed action, trajectory planning, and safety evaluation, and process the necessary information for each operation in the form of inference, planning, and/or reflection (verification).

For example, the query Q may be given in the form of “Describe the structure of the current scene” (semantics), “Identify an object requiring attention” (key object), “Determine a future driving action” (performed action), “Is the trajectory safe” (safety evaluation), and the like, and the LLM 220 may output a response A to this in the form of a numerical trajectory along with a verbal description.

In (i) an inference operation of the LLM 220, the driving logic may be understood from the scene token, in (ii) the planning operation, a predicted trajectory may be generated, and in (iii) the reflection operation, safety verification and correction may be performed to derive a final planned trajectory.

Through such a structure, the system may calculate an optimized trajectory in a stepwise manner while maintaining the explainability of the driving situation. In addition, the LLM 220 may perform consistent decisioning that reflects the basis for determination in a previous operation by accumulating and referencing the responses of each operation.

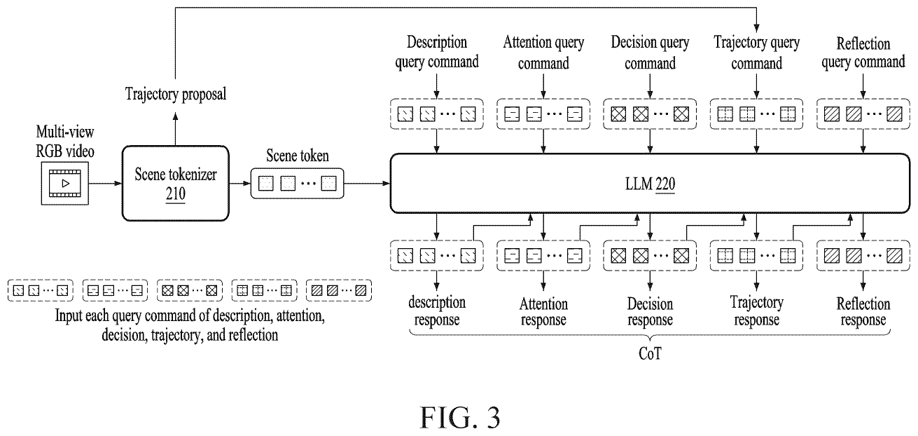

FIG. 3 illustrates an example of a query command in an autonomous driving system, according to one or more embodiments.

The description provided with reference to FIGS. 1A to 2 is generally applicable to FIG. 3.

According to an example, the first query command may be a command query based on a chain-of-thought (CoT). CoT usually involves forming a complete thought process through a series of logically related through processes that are a breakdown of a relatively logically complex problem. Therefore, when performing the inference or making a decision, logical operations within the thought process may be sequentially connected. In the field of AI technology, the CoT is generally a series of inference operations automatically generated by a model. The CoT may be used to describe a logical path to a final result, which may help to improve explainability of the model. In the described example, the CoT may include, for example, five command queries (including description, attention, decision, trajectory, and reflection) and responses corresponding thereto. By applying an attention mechanism to the query quality and the scene token, the LLM may extract information related to the command and generate a corresponding response (including a predicted trajectory and relevant interpretation). To elaborate, the inference of each command query by the LLM may use the scene token. That is to say, each of the responses in FIG. 3 may be based in part on the scene token. As described above, the LLM may extract relevant knowledge from the scene by learning the relationships between the query command and the scene token. Therefore, each of the responses shown in FIG. 3 (i.e., description, attention, decision, trajectory, and reflection responses) may be generated based in part on the scene token. The scene token may contain semantic information about the driving scene, making it a useful reference for all inference steps.

In another implementation, a CoT query command set (including description, attention, decision, trajectory, reflection, and the like) including a multi-view RGB video and a safety-oriented reflection operation may be input, and all relevant scene information may be encoded based on the multi-view RGB video data through the scene tokenizer 210, thereby generating the scene token and the trajectory proposal (e.g., the first trajectory). The trajectory proposal may be embedded into a trajectory query command (e.g., the obtained second query command). Subsequently, the relationships between safety-oriented CoT query and the scene token may be learned using attention parameters of the pre-trained LLM, and the corresponding knowledge may be extracted from the scene according to the logical chain. The LLM 220 network may output a response to each query command, which includes the inference related to the trajectory, the predicted trajectory (e.g., included in the trajectory response), and safety evaluation (e.g., included in the reflection response), and may output an optimized trajectory (e.g., included in the reflection response) based on a result of the safety evaluation.

The electronic device 600 may input the multi-view RGB video into the scene tokenizer 210 to generate a scene token and a trajectory proposal in which semantic information within the scene is encoded. For example, the electronic device 600 may sequentially input the generated scene token and trajectory proposal into the LLM 220 to perform five query commands of description, attention, decision, trajectory, and reflection.

The electronic device 600 may understand the overall situation of a driving scene using a description query command, and extract semantic information such as a composition of the scene, relationships between objects, weather, and a road shape. The electronic device 600 may identify a key object requiring attention within the scene using an attention query command, and determine a location and a movement state of a surrounding object such as a pedestrian or a vehicle. The electronic device 600 may determine an action to be performed in the future based on a current scene and key object information using a decision query command. For example, the electronic device 600 may select a driving strategy such as deceleration, stopping, or turning.

The electronic device 600 may convert a predicted driving action into a specific trajectory form using a trajectory query command, and generate trajectory point coordinates over time. In addition, the electronic device 600 may evaluate the safety of a generated trajectory using a reflection query command, and generate an optimized final planned trajectory by considering whether a navigation command is violated, a yaw angle deviation, smoothness, or the like.

The electronic device 600 may sequentially connect the execution results of each query command to form a CoT. The electronic device 600 may cumulatively refer to the responses generated in each operation of the description, the attention, the decision, the trajectory, and the reflection, and perform determination of a subsequent operation based on the inference result of a previous operation. For example, the electronic device 600 may derive an attention response based on a description response, derive a decision response with reference to the attention response, and then sequentially generate a trajectory response and a reflection response.

According to an example, the electronic device 600 may secure semantic understanding of a driving scene, rationality of decision, and consistency of trajectory generation through the CoT. In addition, the electronic device 600 may output each response result along with a verbal description, thereby improving the explainability of the autonomous driving system.

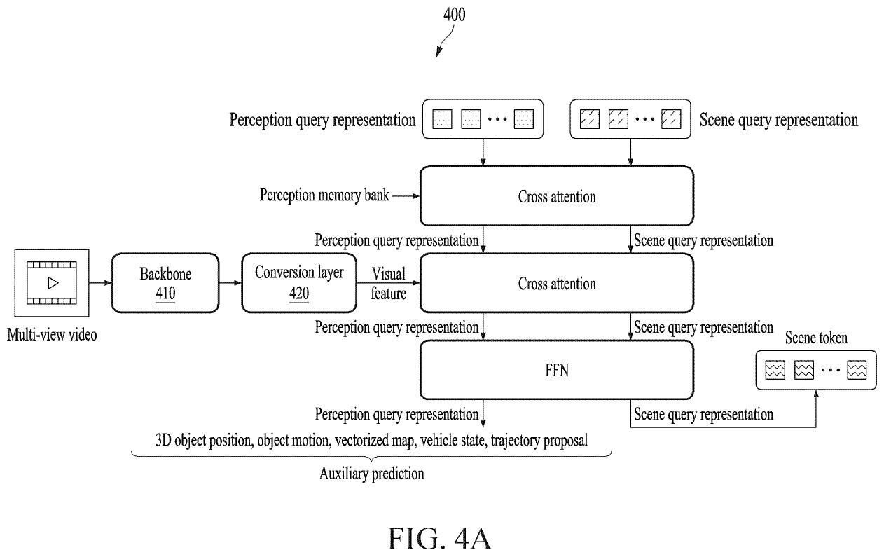

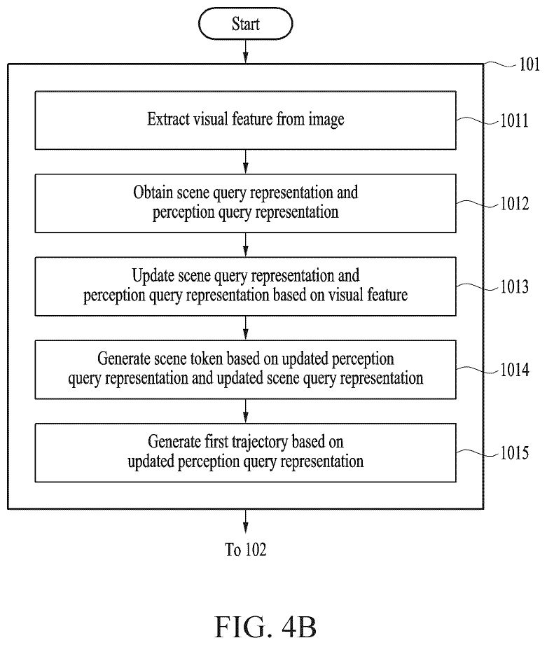

FIG. 4A illustrates an example of a scene tokenizer, according to one or more embodiments.

FIG. 4B illustrates an example of an operation of a scene tokenizer, according to one or more embodiments.

The description provided with reference to FIGS. 1A to 3 is generally applicable to FIGS. 4A and 4B.

Referring to FIG. 4A, a compact scene tokenizer 400 (an example of the scene tokenizer 210) may be used.

The scene tokenizer 400 may extract a visual feature by processing image data input from a multi-view video through a backbone 410. The backbone 410 may synthesize images obtained from multiple views or convert the images into a feature space to generate visual features related to objects in the corresponding scene, road boundaries, traffic signs, driving states of an ego vehicle, or the like.

The electronic device 600 may spatially align the visual features extracted from the backbone 410 using a conversion layer 420, and reconstruct the visual features into information necessary for scene understanding. The conversion layer 420 may refine information such as a location, movement, direction, and speed of an object, and a lane structure based on the visual features, and provide the information as a cross attention input for a subsequent operation.

The electronic device 600 may perform a cross attention operation between a perception query representation and a scene query representation to combine contextual information of the entire scene with local information of a detected object. The cross attention may compensate for a state change of the detected object according to the overall structure of the scene, and alleviate information imbalance caused by interactions between objects or differences in viewpoints.

The electronic device 600 may maintain the perception query representation generated in a previous frame using a perception memory bank, and combine the perception query representation with a perception query representation of a current frame to secure temporal consistency. By utilizing the perception memory bank, the scene tokenizer 400 may perform continuous tracking and state updating of objects with respect to continuous image inputs.

The electronic device 600 may postprocess the cross-attention results through a feedforward network (FFN) to finally integrate the perception query representation and the scene query representation. Through this process, the electronic device 600 may generate a scene token that reflects the relationship between a global structure and a local object within the scene.

The electronic device 600 may perform various prediction tasks, such as trajectory proposal, ego vehicle location estimation, dangerous object detection, and scene summary, using the finally obtained scene token. For example, the electronic device 600 may calculate a distance and a relative speed of an obstacle in a direction of travel of the vehicle based on the scene token, or propose an appropriate driving trajectory according to the road shape.

More specifically, referring to FIGS. 4A and 4B together, the processing process of operation 101 may include operations 1011 to 1015 below.

In operation 1011, the electronic device 600 may extract a visual feature from an image.

According to an example, the compact scene tokenizer 400 may include the backbone 410 network (a general operation module) and the conversion layer 420 (e.g., a projection, a general operation module) for extracting the visual feature from the image. The backbone 410 network may be responsible for extracting visual features from images. Suitable architectures used in computer vision may be used, such as a Convolutional Neural Network (CNN). While it is described generally, the backbone 410 network encompasses specific architectures like CNNs and others that are suitable for feature extraction.

In operation 1012, the electronic device 600 may obtain a scene query representation and a perception query representation. The perception query representation may comprise information indicating/about at least one object in a driving scene, and the scene query representation may comprise information indicating/about semantics of the driving scene. The information about semantics of the driving scene may include a type of scene, relationships between objects, and/or the like.

In some implementations, the perception query representation may be a learnable parameter that is expressed as a predefined P×C tensor, where P is the number of detected objects and C is the number of feature channels.

In some implementations, the scene query representation may also be a learnable parameter, which may be expressed as a predefined S×C tensor, where S is the number of scene queries and C is the number of feature channels.

In operation 1013, the electronic device 600 may update the scene query representation and the perception query representation based on the visual feature.

According to an example, the compact scene tokenizer 400 may further include a cross attention module (a general operation module) and an FFN (a general operation module), through which interactions between visual features, scene query representations, and perception queries may be performed, thereby extracting various pieces of scene information through the query representation.

In operation 1014, the electronic device 600 may generate the scene token based on the updated perception query representation and the updated scene query representation.

According to an example, the updated perception query representation may be converted into an auxiliary prediction, which may include 3D object locations, object movements, vectorized maps (e.g., elements such as boundaries, dividing lines, crosswalks, and centerlines), ego vehicle states, and/or the like, as non-limiting examples.

The auxiliary prediction may be further supervised through data labeling. Rich scene information including object-centric dynamic and static elements may be encoded into the scene token in combination with the updated scene query representation, and this may help the LLM understand a drivable area and recognize intent of various objects. In addition, by explicitly encoding information related to the ego vehicle state, the recognition of the LLM for the ego vehicle state and the role as a driving subject may be enhanced.

In operation 1015, the electronic device 600 may generate the first trajectory based on the updated perception query representation.

For example, the updated perception query representation may be converted into an auxiliary prediction and trajectory proposal, from which the electronic device 600 may obtain the trajectory proposal (e.g., the first trajectory).

The updating of the scene query representation and the perception query representation may achieve effects such as improving prediction accuracy and identifying abnormal data by referencing past data.

The electronic device 600 may obtain a perception memory from the perception memory bank when updating the scene query representation and the perception query representation (such updating based on the visual feature). The perception memory may include a previously updated perception query representation and/or a previously updated scene query representation. The electronic device 600 may update the scene query representation and the perception query representation based on the visual feature and the perception memory.

Similarly, the electronic device 600 may extract various pieces of scene information through the query representation by performing interactions between the visual feature, the perception memory bank, the scene query representation, and the perception query representation; the interactions performed using the cross-attention module and the FFN.

As shown in FIGS. 4A and 4B, the processing process of the compact scene tokenizer 400 may be confirmed.

The visual feature may be extracted from a multi-view video (e.g., an RGB video) using the backbone 410 network and the conversion layer 420. Then, by utilizing a transformer structure (e.g., including two cross attention network layers and one FFN layer), various pieces of scene information are repeatedly encoded into the scene query representation and the perception query representation through the interactions between the scene query representation, the perception query representation, the perception memory bank, and the visual feature, for example. The updated perception query representation may be converted into the additional auxiliary prediction (e.g., including a 3D object location, object movement, vectorized map, ego vehicle state, and the like) and the trajectory proposal. Such additional auxiliary prediction may be fused with the updated scene query representation to obtain a scene token (e.g., a 3D scene token).

Furthermore, the electronic device may input the scene token into the LLM described above to process the autonomous driving trajectory planning as follows:
1) The electronic device 600 may generate a 3D scene token (the scene token) and a trajectory proposal (the first trajectory) based on a multi-view camera image using the compact scene tokenizer 400.
2) The electronic device 600 may perform mutual operations between the 3D scene token and a CoT language query command using the LLM to ultimately obtain a predicted trajectory and a corresponding CoT language response.

Based on this, the end-to-end autonomous driving system may execute a multi-view image of a single frame or multiple frames as an input, and the system may directly output the predicted trajectory and a related description (e.g., including the logic of trajectory generation, safety of trajectory, or the like).

The LLM-based end-to-end autonomous driving systems described herein are not limited to a specific type of knowledge, and may integrate various types of knowledge, such as knowledge related to the trajectory generation, knowledge related to the trajectory safety, and/or the like, and may enhance the explainability and generalization capability of the system by utilizing extensive knowledge, powerful inference ability, and the generalization capability of the LLM. Accordingly, the safety, the explainability, and the generalizability of the autonomous driving system may be improved simultaneously without the need for integration of various knowledge, which typically requires a complex architecture.

The LLM-based end-to-end autonomous driving system may be applied to the trajectory prediction as follows.
1) The autonomous driving system may be applied to high-level driving actions such as acceleration, deceleration, going straight, or turning. A reflection operation for generating a final planned trajectory may be provided.
2) The autonomous driving system may directly convert the planned trajectory into a control signal of the autonomous driving system in a low-level planning process.
3) The autonomous driving system may be applied to a low-level planned trajectory including description to provide a required output format and improved explainability.

The generated trajectory may be consistent with language-based descriptions and improve trajectory performance (e.g., accuracy and safety) by effectively utilizing such descriptions.

In a training operation of training the autonomous driving system, the following strategies may be provided to secure a sufficient amount of data for the LLM to learn reflection capability.
1) In the training operation of the autonomous driving system, a trajectory that requires reflection may be generated using various methods, such as cross-verification on a training set or directly using a model with somewhat lower performance to generate a trajectory from the training set. In a subsequent reflection portion of the LLM, one of the trajectories generated during the training may be randomly sampled and used as an input.
2) The trajectory portion of the LLM may have labeled trajectories during a supervision process. Therefore, the trajectory portion may be masked in the reflection portion to prevent leakage of the labeled trajectories. That is, in the reflection portion, related information for the process of other operations may be seen, however, related information for the trajectory operation may not be seen.

In some implementations, in a test operation of the autonomous driving system, the results of all operations of the CoT may be generated sequentially. In the reflection operation, a prediction result of the trajectory operation may be obtained as an input thereof, and then the LLM may simulate and evaluate the safety of the predicted trajectory, describe an optimization method, and output an optimized trajectory.

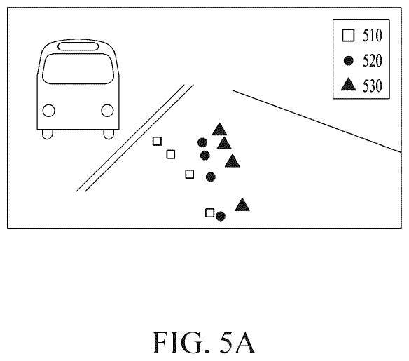

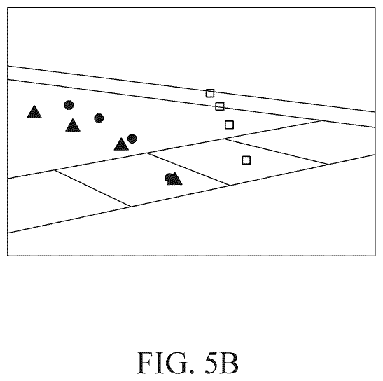

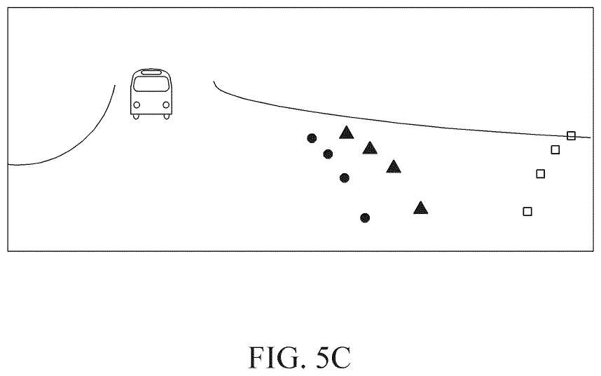

FIGS. 5A to 5C illustrate results obtained through a method of generating an autonomous driving trajectory, according to one or more embodiments.

The description provided with reference to FIGS. 1A to 4B is generally applicable to FIGS. 5A to 5C, and any repeated description related thereto may be omitted.

The methods and examples described herein have been tested extensively on specific datasets, and it has thereby been confirmed that accuracy of the autonomous driving systems described herein exceeds that of a system of the related art. Several effects may be confirmed along with the test results through FIGS. 5A and 5B. Among them, a trajectory 510 predicted by a system of the prior art is indicated by a hollow square, a final planned trajectory (e.g., the third trajectory) 520 after reflection optimization provided by embodiments described herein is indicated by a filled circle, and a labeled expert trajectory 530 is indicated by a filled triangle.

Referring to FIG. 5A, the trajectory 510 predicted by the system of the prior art is toward the left, which may have a risk of collision with an oncoming vehicle. It may be confirmed that the final planned trajectory 520 after reflection optimization as described herein is correct (going straight), which avoids the risk of collision.

Referring to FIG. 5B, the trajectory 510 predicted by the system of the prior art has a risk of going beyond a drivable area. The final planned trajectory 520 after reflection optimization as described herein has a correct direction and does not go beyond the drivable area.

Referring to FIG. 5C, the trajectory 510 predicted by the system of the prior art is in a wrong direction and there is a risk of going beyond the drivable area. The final planned trajectory 520 after reflection optimization as described herein has a correct direction, which not only avoids the risk of collision with an oncoming vehicle but also assures not going beyond the drivable area.

FIG. 6 illustrates an example of an electronic device, according to one or more embodiments.

The description provided with reference to FIGS. 1A to 5 is generally applicable to FIG. 6.

The technical solutions provided in the examples and embodiments described herein may be applied not only to smart driving vehicles, but also to servers such as independent physical servers, server clusters or distributed systems including a plurality of physical servers, and cloud servers, as non-limiting examples.

The electronic device 600 may include a processor, and optionally, a transceiver and/or memory coupled to the processor, and the processor may be configured to perform operations of the methods described herein.

As shown in FIG. 6, the electronic device 600 may include a processor 610 and a memory 630. The processor 610 and the memory 630 may be connected with each other, for example, via a bus 620. Optionally, the electronic device 600 may further include a transceiver 640, and the transceiver 640 may be used for data exchange, such as transmission of data and/or reception of data between the electronic device and another electronic device. It should be noted that in actual applications, the transceiver 640 is not limited to one, and the structure of the electronic device 600 does not constitute a limitation to the examples of the disclosure. Optionally, the electronic device 600 may be a first network node, a second network node, or a third network node.

The processor 610 may be a CPU, a general-purpose processor, a digital signal processor (DSP), an application specific integrated circuit (ASIC), a field programmable gate array (FPGA), or other programmable logic units (PLUS), a transistor logic device, a hardware component, or any combination thereof. Various example logic blocks, modules, and circuits described herein may be implemented or executed. The processor 610 may also be a combination that realizes computing functions including, for example, a combination of one or more microprocessors or a combination of a DSP and a microprocessor.

The bus 620 may include a path for transmitting information between the above-described components. The bus 620 may be a peripheral component interconnect (PCI) bus or an extended industry standard architecture (EISA) bus. The bus 620 may be classified into an address bus, a data bus, and a control bus. For convenience of illustration, only one bold line is shown in FIG. 6, but there may not be only one bus or only one type of bus.

The memory 630 may be a read-only memory (ROM) or other type of static storage device capable of storing static information and instructions, a random access memory (RAM) or other type of dynamic storage device capable of storing information and instructions, an electrically erasable programmable read-only memory (EEPROM), a CD-ROM or other optical disc storage, optical disc storage (including compressed optical discs, laser discs, optical discs, digital versatile discs, Blu-ray discs, and the like), disc storage media, other magnetic storage devices, or any other computer-readable medium that may be used to carry or store a computer program, but is not limited thereto.

The memory 630 may be used to store a computer program for executing the examples herein and controlled by the processor 610. The processor 610 may be configured to execute a computer program stored in the memory 630 to implement the operations of the method described above.

The computing apparatuses, the vehicles, the electronic devices, the processors, the memories, the sensors, the vehicle/operation function hardware, the displays, the information output system and hardware, the storage devices, and other apparatuses, devices, units, modules, and components described herein, including descriptions with respect to respect to FIGS. 1-6, are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit (ALU), a digital signal processor (DSP), a microcomputer, a programmable logic controller, a field-programmable gate array (FPGA), a programmable logic array (PLU), a microprocessor, or any other device or combination of devices that is configured to respond to and execute instructions (e.g., code or coding) in a defined manner to achieve a desired result. In one example, a processor or computer includes, or is connected to, one or more memories storing the instructions or software that are executed by the processor or computer. Hardware components implemented by a processor or computer may execute the instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both, and thus while some references may be made to a singular processor or computer, such references also are intended to refer to multiple processors or computers. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing. Thus, references to a processor herein mean processing circuitry (e.g., circuitry that includes one or more processing element(s) circuits). One or more processors comprising processing circuitry also refers to each processor comprising processing circuitry, as well as some or all of the one or more processors comprising the same processing circuitry. In addition, processors(s) and controller(s), as a non-limiting example, do not mean human processing or human control, but rather, refer to hardware components as described herein, as non-limiting examples.

The methods illustrated in, and discussed with respect to, FIGS. 1-6 that perform the operations described in this application are performed by computing hardware, for example, by one or more processors or computers, implemented as described above implementing the instructions (e.g., computer or processor/processing device readable instructions) or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations. References to a processor, or one or more processors, as a non-limiting example, configured to perform two or more operations refers to a processor or two or more processors being configured to collectively perform all of the two or more operations, as well as a configuration with the two or more processors respectively performing any corresponding one of the two or more operations (e.g., with a respective one or more processors being configured to perform each of the two or more operations, or any respective combination of one or more processors being configured to perform any respective combination of the two or more operations). Likewise, a reference to a processor-implemented method is a reference to a method that is performed by one or more processors or other processing or computing hardware of a device or system.

The instructions or software to control computing hardware, for example, one or more processors or computers, to implement the hardware components and perform the methods as described above may be written as computer programs, code segments, or other executable instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. Thus, references herein to storage media mean storage media hardware, and does not mean to transitory media, nor a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as a multimedia card or a micro card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A method of generating an autonomous driving trajectory performed by one or more processors, the method comprising:
generating a scene token and a first trajectory based on a collected image;
obtaining a first query command comprising a first query for a logic of trajectory generation and a second query for safety of the trajectory; and
generating a third trajectory based on the scene token, the first trajectory, and the first query command using a large language model (LLM),
wherein the third trajectory is obtained by processing a second trajectory based on second information obtained in response to the second query, wherein
the second trajectory is obtained based on first information obtained in response to the first query, and wherein
the first information and the second information are obtained based on the scene token, the first trajectory, and the first query command.

2. The method of claim 1, wherein the second information comprises at least one of information about whether a direction of the second trajectory corresponds to a direction of a navigation command or information about whether a yaw angle between any pair of adjacent trajectory points in the second trajectory exceeds a first threshold value.

3. The method of claim 2, wherein the generating of the third trajectory comprises, based on determining, according to the second information, that the direction of the second trajectory does not match the direction of the navigation command, adjusting a vertical coordinate value of a trajectory point within the second trajectory so that the direction of the second trajectory corresponds to the direction of the navigation command, and determining the third trajectory corresponding to the adjusted second trajectory.

4. The method of claim 2, wherein the generating of the third trajectory comprises, based on determining, according to the second information, that the yaw angle between any pair of adjacent trajectory points in the second trajectory exceeds the first threshold value, incrementally increasing a horizontal coordinate value of a trajectory point within the second trajectory, adjusting a fluctuation range of the vertical coordinate value to be less than a second threshold value, and determining the third trajectory corresponding to the adjusted second trajectory.

5. The method of claim 1, wherein the generating of the third trajectory comprises:
generating description information about processing of the second trajectory based on the second information; and
obtaining the third trajectory by processing the second trajectory based on the description information.

6. The method of claim 1, wherein the generating of the third trajectory comprises:
generating the first information and the second information based on the scene token, the first trajectory, and the first query command;
generating the second trajectory for the first information based on the scene token, the first trajectory, the first query command, and the first information; and
obtaining the third trajectory by processing the second trajectory based on the second information.

7. The method of claim 1, wherein the first information comprises at least one of:
information related to a driving scene;
information related to a key object in the driving scene;
information related to a driving action to be performed; or
information related to prediction of the second trajectory.

8. The method of claim 1, wherein the generating of the third trajectory comprises:
obtaining a second query command by embedding the first trajectory into the first query command; and
generating the third trajectory based on the scene token and the second query command.

9. The method of claim 1, wherein the generating of the scene token and the first trajectory based on the collected image comprises:
extracting a visual feature from the image;
obtaining a scene query representation comprising information indicating semantics of a driving scene, and a perception query representation comprising information indicating at least one object in the driving scene;
updating the scene query representation and the perception query representation based on the visual feature;
generating the scene token based on the updated perception query representation and the updated scene query representation; and
generating the first trajectory based on the updated perception query representation.

10. The method of claim 9, wherein the updating of the scene query representation and the perception query representation based on the visual feature comprises:
obtaining a perception memory comprising a previously updated perception query representation and/or a previously updated scene query representation; and
updating the scene query representation and the perception query representation based on the visual feature and the perception memory.

11. An electronic device comprising:
one or more processors comprising processing circuitry; and
a memory storing instructions,
wherein the instructions, when executed by the one or more processors, cause the electronic device to:
generate a scene token and a first trajectory based on a collected image;
obtain a first query command comprising a first query for a logic of trajectory generation and a second query for safety of the trajectory; and
generate a third trajectory based on the scene token, the first trajectory, and the first query command using a large language model (LLM), wherein
the third trajectory is obtained by processing a second trajectory based on second information obtained in response to the second query, wherein
the second trajectory is obtained based on first information obtained in response to the first query, and wherein
the first information and the second information are obtained based on the scene token, the first trajectory, and the first query command.

12. The electronic device of claim 11, wherein the second information comprises at least one of information about whether a direction of the second trajectory corresponds to a direction of a navigation command or information about whether a yaw angle between any pair of adjacent trajectory points in the second trajectory exceeds a first threshold value.

13. The electronic device of claim 12, wherein the instructions, when executed by the one or more processors, cause the electronic device to, based on determining, according to the second information, that the direction of the second trajectory does not match the direction of the navigation command, adjust a vertical coordinate value of a trajectory point within the second trajectory so that the direction of the second trajectory corresponds to the direction of the navigation command, and determine the third trajectory corresponding to the adjusted second trajectory.

14. The electronic device of claim 12, wherein the instructions, when executed by the one or more processors, cause the electronic device to, based on determining, according to the second information, that the yaw angle between any pair of adjacent trajectory points in the second trajectory exceeds the first threshold value, incrementally increase a horizontal coordinate value of a trajectory point within the second trajectory, adjust a fluctuation range of the vertical coordinate value to be less than a second threshold value, and determine the third trajectory corresponding to the adjusted second trajectory.

15. The electronic device of claim 11, wherein the instructions, when executed by the one or more processors, cause the electronic device to:
generate description information about processing of the second trajectory based on the second information; and
obtain the third trajectory by processing the second trajectory based on the description information.

16. The electronic device of claim 11, wherein the instructions, when executed by the one or more processors, cause the electronic device to:
generate the first information and the second information based on the scene token, the first trajectory, and the first query command;
generate the second trajectory for the first information based on the scene token, the first trajectory, the first query command, and the first information; and
obtain the third trajectory by processing the second trajectory based on the second information.

17. The electronic device of claim 11, wherein the first information comprises at least one of:
information related to a driving scene;
information related to a key object in the driving scene;
information related to a driving action to be performed; or
information related to prediction of the second trajectory.

18. The electronic device of claim 11, wherein the instructions, when executed by the one or more processors, cause the electronic device to:
obtain a second query command by embedding the first trajectory into the first query command; and
generate the third trajectory based on the scene token and the second query command.

19. The electronic device of claim 11, wherein the instructions, when executed by the one or more processors, cause the electronic device to:
extract a visual feature from the image;
obtain a scene query representation comprising information indicating semantics of a driving scene, and a perception query representation comprising information indicating at least one object in the driving scene;
update the scene query representation and the perception query representation based on the visual feature;
generate the scene token based on the updated perception query representation and the updated scene query representation; and
generate the first trajectory based on the updated perception query representation.

20. A non-transitory computer-readable storage medium storing instructions executable in a hardware device,
wherein the instructions are configured to cause the hardware device to:
generate a scene token and a first trajectory based on a collected image;
obtain a first query command comprising a first query for a logic of trajectory generation; and
generate a third trajectory based on the scene token, the first trajectory, and the first query command using a large language model (LLM), wherein
the third trajectory is obtained by processing a second trajectory, wherein
the second trajectory is obtained based on first information obtained in response to the first query, and wherein
the first information is obtained based on the scene token, the first trajectory, and the first query command.
